(19) United States
(12) Patent Application Publication
(10) Pub. No.: US 2024/0196292 A1
(43) Pub. Date: Jun. 13, 2024

(54) A METHOD AND SYSTEM FOR REPLACEMENT OF ENERGY AND CAPACITY-CONSTRAINED 6G AERIAL CELLS

(71) Applicant: SAMSUNG ELECTRONICS CO., LTD., SUWON-SI, GYEONGGI-DO (KR)

(72) Inventors: TUSHAR VRIND, Bengaluru (IN); LALIT KUMAR PATHAK, Bengaluru (IN); SAMIR KUMAR MISHRA, Bengaluru (IN); DEBABRATA DAS, Bengaluru (IN)

(21) Appl. No.: 18/553,542

(22) PCT Filed: Mar. 31, 2022
(86) PCT No.: PCT/KR2022/004583

§ 371 Date: Sep. 29, 2023

(30) Foreign Application Priority Data
Mar. 31, 2021 (IN) 202141014797

(51) Int. Cl. H04W 36/08; H04W 36/00; H04W 76/27; H04W 84/06

(52) U.S. Cl. CPC H04W 36/083; H04W 36/0061; H04W 76/27; H04W 84/06

(57) ABSTRACT

A method of replacing a source aerial cell with a target aerial cell includes receiving a transfer request from the target aerial cell to transfer link related parameters between the source aerial cell and UE and link related parameters between the source aerial cell and a core network. The method further includes transmitting each of the link related parameters to the target aerial cell in response to the received transfer request and further notifying, via a notification message, a change in PCID of the source aerial cell to the UE. The method furthermore includes transmitting a cell switching request to the target aerial cell along with positioning information of the source aerial cell for a switchover of a communication operation with the UE and terrestrial cells served by the source aerial cell, and thereafter the target aerial cell moves to a hovering position indicated by the transmitted positioning information.

### TECHNICAL FIELD

The present application claims priority to Indian Provisional Patent Application No. 202141014797, filed on Mar. 31, 2021, the contents of which are incorporated by reference herein in their entirety.

The present disclosure relates to wireless communication systems and, more specifically, to a method and system for the replacement of energy and capacity-constrained 6G aerial cells in a wireless communication system.

### BACKGROUND ART

Internet connectivity has grown in popularity in recent years and now reaches more people than ever before. Users may access the Internet through various devices that are commonly referred to as user equipment (UE). Though there is a rapid growth in the data requirements from UE, this demand usually changes fast and can be difficult to predict. For example, there may be an increased demand from certain areas during sports and cultural events, traffic congestion on roads, etc. Servicing such dynamic requirements of data through fixed assets like a terrestrial base station in the cellular network becomes a challenge for operators, as it can be difficult to scale beyond a point during high demand.

### DISCLOSURE OF INVENTION

### Technical Problem

The principal object of the embodiments herein is to disclose methods of replacing a source aerial cell with a target aerial cell.

Another object of the embodiments herein is to disclose source aerial cell replaceable by a target aerial cell, the source aerial cell comprising at least one processor.

Another object of the embodiments herein is to disclose a target aerial cell configured to replace a source aerial cell, the target aerial cell comprising at least one processor.

### Solution to Problem

A method of replacing a source aerial cell with a target aerial cell includes receiving a transfer request from the target aerial cell to transfer each of a first plurality of link related parameters between the source aerial cell and a plurality of user equipment (UE) and a second plurality of link related parameters between the source aerial cell and a core network. The method further includes transmitting, to the target aerial cell, each of the first plurality of link related parameters and the second plurality of link related parameters in response to the received transfer request. The target aerial cell stores each of the first plurality of link related parameters and the second plurality of link related parameters in a link database and performs a link replication process for replication of the each of the first plurality of link related parameters and the second plurality of link related parameters. The method further includes notifying, to the plurality of UE, via a notification message after completion of the link replication process at the target aerial cell, a change in Physical Cell Identifier (PCID) of the source aerial cell and thereafter transmitting, to the target aerial cell after an acknowledgment of the notification message by the plurality of UE, a cell switching request along with positioning information of the source aerial cell for a switchover of a communication operation with the plurality of UE and terrestrial cells of the core network served by the source aerial cell. The target aerial cell moves to a hovering position indicated by the transmitted positioning information, and establishes a communication with the plurality of UE and the terrestrial cells served by the source aerial cell based on the link replication process and the switch over of the communication operation.

A method of placing a target aerial cell in place of a source aerial cell includes transmitting a transfer request to the source aerial cell to transfer each of a first plurality of link related parameters between the source aerial cell and a plurality of user equipment (UE) and a second plurality of link related parameters between the source aerial cell and a core network. The method further includes receiving each of the first plurality of link related parameters and the second plurality of link related parameters in response to the transmitted transfer request, and performing a link replication process for replication of each of the received first plurality of link related parameters and the received second plurality of link related parameters. The source aerial cell notifies the plurality of UE a change in Physical Cell Identifier (PCID) of the source aerial cell via a notification message after completion of the link replication process. The method further includes receiving, from the source aerial cell, a cell switching request along with positioning information of the source aerial cell for a switchover of a communication operation with the plurality of UE and terrestrial cells of the core network served by the source aerial cell. The source aerial cell transmits the cell switching request to the target aerial cell after an acknowledgment of the notification message by the plurality of UE. The method thereafter includes controlling the target aerial cell to move to a hovering position indicated in the received positioning information and establishing, after the movement of the target aerial cell to the hovering position, a communication with the plurality of UE and the terrestrial cells served by the source aerial cell based on the link replication process and the switch over of the communication operation.

A source aerial cell is configured to be replaced by a target aerial cell. The source aerial cell includes at least one processor configured to receive a transfer request from the target aerial cell to transfer each of a first plurality of link related parameters between the source aerial cell and a plurality of user equipment (UE) and a second plurality of link related parameters between the source aerial cell and a core network. The at least one processor of the source aerial cell is further configured to transmit, to the target aerial cell, each of the first plurality of link related parameters and the second plurality of link related parameters in response to the received transfer request, and notify, to the plurality of UE via a notification message after completion of a link replication process at the target aerial cell, a change in Physical Cell Identifier (PCID) of the source aerial cell. The at least one processor of the source aerial cell is furthermore configured to transmit, to the target aerial cell after an acknowledgment of the notification message by the plurality of UE, a cell switching request along with positioning information of the source aerial cell for a switchover of a communication operation with the plurality of UE and terrestrial cells of the core network served by the source aerial cell. The target aerial cell moves to a hovering position indicated by the transmitted positioning information, and establishes a communication with the plurality of UE and the terrestrial cells served by the source aerial cell based on the link replication process and the switch over of the communication operation.

A target aerial cell is configured to replace a source aerial cell. The target aerial cell includes at least one processor configured to transmit a transfer request to the source aerial cell to transfer each of a first plurality of link related parameters between the source aerial cell and a plurality of user equipment (UE) and a second plurality of link related parameters between the source aerial cell and a core network. The at least one processor of the target aerial cell is further configured to receive each of the first plurality of link related parameters and the second set of link related parameters in response to the transmitted transfer request, and perform a link replication process for replication of each of the received first plurality of link related parameters and the received second plurality of link related parameters. The at least one processor of the target aerial cell is furthermore configured to receive, from the source aerial cell, a cell switching request along with positioning information of the source aerial cell for a switchover of a communication operation with the plurality of UE and terrestrial cells of the core network served by the source aerial cell. The source aerial cell transmits the cell switching request to the target aerial cell after an acknowledgment of a notification message by the plurality of UE in response to the notification message transmitted by the source aerial to the plurality of UE. Thereafter, the at least one processor of the target aerial cell is further configured to control the target aerial cell to move to a hovering position indicated in the received positioning information, and then establish, after the movement of the target aerial cell to the hovering position, a communication with the plurality of UE and the terrestrial cells served by the source aerial cell based on the link replication process and the switch over of the communication operation.

### BRIEF DESCRIPTION OF DRAWINGS

These and other features and aspects of the present invention will become better understood when the following detailed description is read with reference to the accompanying drawings in which like characters may represent like parts throughout the drawings, wherein:

FIG. 1 is a diagram illustrating a first replacement scheme of replacing the source aerial cell with the target aerial cell illustrating a call flow for aerial cell handover, in accordance with a first solution;

FIG. 2 is a diagram illustrating a second replacement scheme of replacing the source aerial cell with the target aerial cell illustrating a call flow for aerial cell link management, in accordance with a second solution;

FIG. 3 is a diagram illustrating an aerial cell replacement scenario for energy depleted cell, in accordance with an embodiment of the present disclosure;

FIG. 4 is a flow chart of method steps for replacing the source aerial cell 304 with the target aerial cell 306 of FIG. 3, in accordance with an embodiment of the present disclosure;

FIG. 5 is a line diagram representing a call flow for aerial cell replacement using ACC Protocol, in accordance with an embodiment of the present disclosure; and

FIG. 6 is a block diagram illustrating an exemplary implementation in accordance with the embodiment of the present invention, and a typical hardware configuration of the system in the form of a computer system, in accordance with an embodiment of the present disclosure.

### MODE FOR THE INVENTION

It should be understood at the outset that although illustrative implementations of the embodiments of the present disclosure are illustrated below, the present invention may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

Embodiments of the present invention will be described below in detail with reference to the accompanying drawings.

The Third Generation Partnership Project (3GPP) is considering Aerial Network, referred to as Non-Terrestrial Network (NTN) deployment, to address the scaling scenarios in the next-generation networks. NTN may take up to 5-10 years to be standardized and deployed. NTN is a fundamental enabler for dynamic scaling in beyond 5G and 6th Generation (6G) networks. However, limited studies are available on 6G. NTN uses the concept of aerial or airborne platforms carrying cells. These aerial cells serve the user equipment (UE) according to the traffic demand.

Aerial cells can be deployed at different altitudes and come with multiple challenges. LAP-based aerial cells hover at an altitude of a few hundred meters and offer a good option for extending coverage and enhancing the capacity of a terrestrial cell. The altitude and position of the LAP-based aerial cells can be adjusted dynamically to maximize the coverage and capacity utilization in the network. LAP-based aerial cells correspond to quadrotor drones and have limited payloads (just over a few kilograms). However, due to the capability to carry a small payload, the battery size is limited, and so it has flying and hovering time constraints of barely a few hours. The wireless network capacity offered by such LAP-based aerial cells is directly proportional to the weight of the payload, which is comprised of the compact antennae and communication system that it can carry on board. As the payload size is limited, there is a trade-off between the capacity offered and the battery size. Being airborne, drones can harness solar power, though it is limited, due to the small space on the form factor of the drone (solar panels require large surface area) and the unavailability of natural light after sunset. Hence, it is being studied in 3GPP the support of Unmanned Aerial System as aerial cells, also referred to as U×NB, with aerial cell replacement as a key requirement to be supported beyond 5G.

The comparative solutions discuss the optimized ways to replace the battery of a drone or replace the energy-depleted drones for the longevity of usage. However, the comparative solutions have several shortcomings and problems in terms of applicability during implementation such as the battery swapping mechanism in drones using docking stations, or the replacement of the drones by a new drone with a fully charged battery. With respect to the battery swapping mechanism, the battery swapping takes a long time (over 15 sec). The longer the battery swapping time will result in disconnection of all of the ongoing UE sessions through the LAP-based aerial cell. Hence, the other alternative which is the replacement of the drones by a new drone with a fully charged battery may work. However, it also has important challenges, i.e., the replacement of new drones might not provide seamless session continuity for all UE that are connected with the drone to be replaced.

The problem of sessions transfer from a serving aerial cell i.e., source aerial cell to a new aerial cell (i.e., target aerial cell) during replacement cannot be considered like a handover or redirection in a terrestrial network, as there are several new challenges as described below. The comparative solutions on UE handover from the source aerial cell to the target aerial cell describes available schemes of handovers in the terrestrial network which are suitable for scenarios like user mobility or load balancing in the NTN. However, they do not consider the critical factor of delay in functionality readiness for continuity of ongoing communication sessions of the UE when used in the LAP-based aerial cell replacement scenario. Thus, using the available handover schemes described in comparative solutions, there will be a significant interruption in communication for UE served by the aerial cell in the case of LAP-based aerial cell replacement. The interruption is expected at every replacement of an aerial cell and based on the feasibility of a LAP-based aerial cell design, expected once every hour (one hour is the battery life of a drone). The interruption severely downgrades the capacity and end-user experience of gaming and multimedia playback.

With respect to the above-described implementation scenarios, the comparative solutions describing handling of replacement of LAP based aerial cells (also referred to as drones) has not addressed the critical challenges of seamless continuity specific to aerial communication such as a delay in positioning (altitude and location) for the target aerial cell, managing handover (HO) with minimal HO delay, minimization of backhaul synchronization time between target aerial cell and backhaul terrestrial nodes (base station or core network) over the wireless channel, and the like.

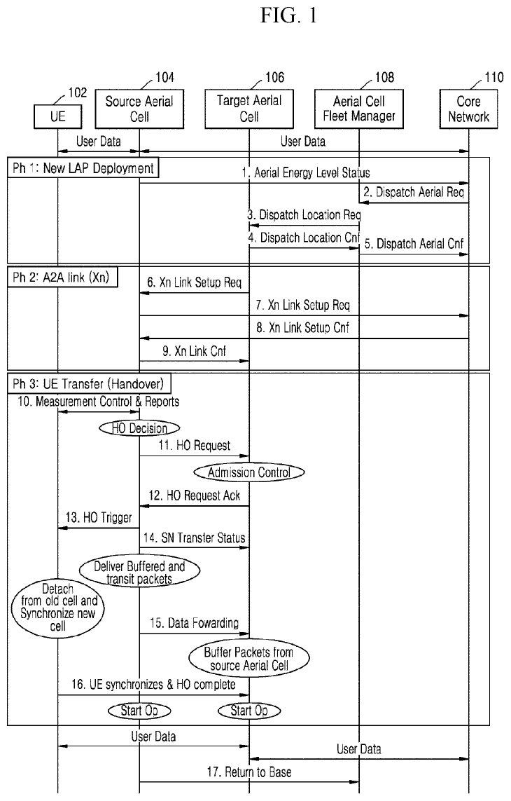

Some classical schemes as per the comparative solutions are also described below that illustrate the above-mentioned problems. A first replacement scheme of replacing the source aerial cell with the target aerial cell illustrating a call flow for aerial cell handover is shown in FIG. 1 of the drawings, in accordance with a first comparative solution. As soon as the target aerial cell comes near the energy-depleted source aerial cell, the aerial cell handover procedure is performed. The aerial cell handover procedure gets triggered for all the UE that are served by the source aerial cell, to first synchronize the UE with the target aerial cell and then connect them with the target aerial cell. The aerial cell handover scheme is very similar to the procedure for a Next-generation NodeB (gNB) handover over the Xn interface in 5G New Radio (NR). In accordance with FIG. 1, the aerial cell handover procedure based call flow includes three phases Ph 1, Ph 2, and Ph 3.

Steps 10 to step 16 of FIG. 1 illustrates the third phase (Ph 3) of UE 102 transfer (handover) to the target aerial cell 106. In step 10, the UE 102 connected to the source aerial cell 104, receives a measurement control message. The UE 102 sends the measurement report with reference signal power and quality of the target aerial cell 106. Then at step 11 of FIG. 1, the source aerial cell 104 decides to handover and sends the HO request to the target aerial cell 106. Thereafter, the target aerial cell 106 acknowledges the HO Request at step 12 of FIG. 1. Further, at step 13 of FIG. 1, the source aerial cell 104 triggers the HO request to the UE 102, and further at steps 14 and 15 of FIG. 1, the Serial Number (SN) of the Data Link Layer and the buffered packets at the source aerial cell 104 is shared with the target aerial cell 106. Furthermore, at step 16 of FIG. 1, the UE 102 initiates an uplink synchronization procedure with the target aerial cell 106 and performs either a 2-step or a 4-step Random Access on the Random-Access Channel (RACH). Thereafter, the source aerial cell 104 stops communicating with the UE 102 and with the terrestrial cell on the back-haul link. There is also a path switch for the backhaul link from the terrestrial cell towards the target aerial cell 106 and data transfer starts between the UE 102 and the target aerial cell 106. All the UE that were in the connected state with the source aerial cell 104 at the beginning of this phase go through steps 10 to 16 of FIG. 1. Finally, at step 17 of FIG. 1, the source aerial cell 104 returns to the aerial cell Fleet Manager 108 base and recovers from lost energy by getting charged in a docking station, or by being replaced with a fully charged battery.

As evident from steps 10 to 16 of FIG. 1, there is a substantial delay in the entire handover procedure for all the UE due to the third phase, thereby causing a proportional interruption in the data session between the UE 102 and the target aerial cell 106.

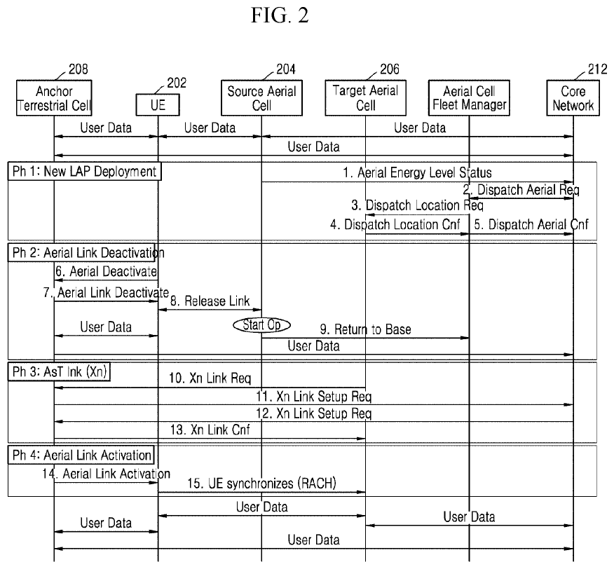

Now a second replacement scheme of replacing the source aerial cell with the target aerial cell illustrating a call flow for aerial cell link management is shown in FIG. 2 of the drawings, in accordance with a second comparative solution. In this scheme, in between the replacement of the source aerial cell, the aerial link is torn down by procedures like Carrier Aggregation (CA), Dual Connectivity (DC) deactivation, or release procedure. However, it leads to loss of user throughput during this period of replacement. FIG. 2 depicts four phases (Ph 1, Ph 2, Ph 3, and Ph 4) of procedures for aerial cell link management.

Step 6 to step 9 of FIG. 2, captures the second phase of the aerial link deactivation between the UE 202 and the source aerial cell 204, while the UE 202 continues to be served by the terrestrial cell, which acts as an anchor. As soon as the source aerial cell 204 informs the terrestrial cell about its unavailability over the Xn interface, the aerial link deactivation request is shared with the UE 202 (step 7 of FIG. 2). Further, in step 8 of FIG. 2, the procedure of release is initiated between the UE 202 and the source aerial cell 204, after which the source aerial cell 204 returns to the base (step 9 of FIG. 2). Furthermore, all of the UE that were in the connected state with the source aerial cell 204 at the beginning of the second phase go through steps 6 to 9 of FIG. 2.

Further, Step 10 to Step 13 of FIG. 2, captures the third phase of establishing the Xn link in-between the target aerial cell 206 and anchor terrestrial cell 208. Once the target aerial cell 206 navigates to the neighbourhood of the source aerial cell 204, at step 10 of FIG. 2, it establishes an Xn interface with the anchor terrestrial cell 208. The anchor terrestrial cell 208 refers this request back to the core network 212 with the credentials of the target aerial cell 206 that it receives in the Xn link request, as step 11 of FIG. 2. In step 12 of FIG. 2, the core network 212 confirms the request after authenticating target aerial cell 206 credentials. The Xn link gets established in step 13 of FIG. 2.

The fourth phase of link management covers the aerial link activation between the UE and the target aerial cell 206. In step 14 of FIG. 2, the terrestrial link requests the UE 202 to add the aerial link via CA or DC, and in step 15 of FIG. 2, the UE 202 triggers a Random-Access Channel (RACH) based UL synchronization for obtaining the Timing Advance (TA) with the target aerial cell 206. The aerial link is activated with UL and DL data traffic. All the UE that were in the connected state with the source aerial cell 204 at the beginning of the second phase go through steps 14 to 15 of FIG. 2.

It is evident from steps 6 through steps 15 of FIG. 2 that there is a substantial delay in the entire link management procedure, for all of the UE due to the second phase and the fourth phase. The delay in performing the steps causes a proportional degradation in the data throughput, as the UE 202 cannot be served by the source aerial cell 204, between Step 6 to Step 15.

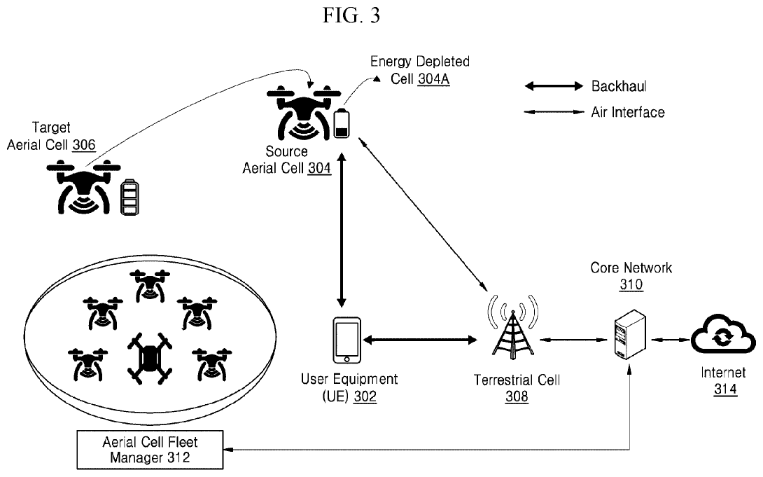

FIG. 3 is a diagram illustrating an aerial cell replacement scenario for an energy-depleted cell, according to an embodiment of the present disclosure. FIG. 3 depicts a system that includes a User Equipment (UE) 302, a source aerial cell 304, which is to be replaced due to energy depleted cell 304A, a target aerial cell 306, a terrestrial cell 308, a core network 310 connected to internet 314, and an aerial cell fleet manager 312. Each of the source aerial cell 304 and the target aerial cell 306 includes one or more processors for controlling the communication procedure between the components of the system using a communication interface. The system may include a plurality of UE connected to the source aerial cell 304 via a wireless interface (e.g., using backhaul link). Further, the one or more processors may control and execute each of the operations required for the replacement of the source aerial cell 304 with target aerial cell 306.

As shown in FIG. 3, in aerial communication, there are two ways to serve the UE. One is exclusively serving the UE by the aerial cell (source aerial cell 304) and the other is serving the UE by both the aerial cell and the terrestrial cell 308 by applying Carrier Aggregation (CA) technique or Dual Connectivity (DC) technique. In such a scenario, both the terrestrial cell 308 and the aerial cell (source aerial cell 304) offer resource allocation to the UE on different carriers. The wireless backhaul link between the aerial cell and the terrestrial network could either be on a Point to Point (P2P) dedicated carrier link or could be on an Integrated Access Backhaul (IAB) link using the same carrier as used between the UE 302 and the terrestrial cell 308.

The aerial cell fleet manager 312 manages a fleet of aerial cells (of different capabilities) and ensures that the aerial cell (source aerial cell 304 or target aerial cell 306) is brought and positioned at the right location and altitude to serve the UE in the wireless communication network. FIG. 3 depicts a deployment scenario of deploying the target aerial cell 306 for replacing the source aerial cell 304. As soon as the source aerial cell 304 is energy-depleted (shown by a low battery level indicator 304A in the source aerial cell 304), the information gets forwarded to the aerial cell fleet manager 312, which dispatches a fully charged aerial cell (the target aerial cell 306) to the location of the source aerial cell 304.

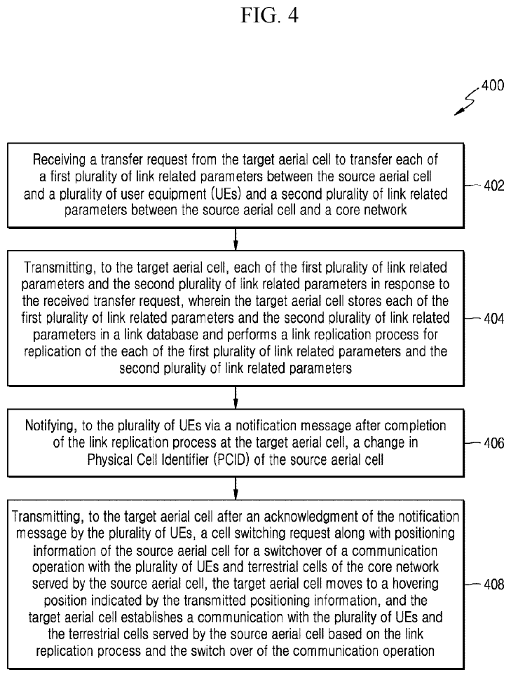

Now, a flow chart of method steps will be described with reference to FIG. 4 of the Drawings. FIG. 4 is a flow chart of method steps for replacing the source aerial cell 304 with the target aerial cell 306 of FIG. 3, in accordance with an embodiment of the present disclosure. In particular, FIG. 4 illustrates a method 400 for replacement of the source aerial cell 304 with the target aerial cell 306 within the system shown in FIG. 3. Moreover, FIG. 4 depicts an aerial cell cloning (ACC) protocol which reduces the delays substantially (near zero) in handover and data session interruption between a source aerial cell connected to UE and a core network during replacement with another aerial cell (target aerial cell).

The method 400 comprises receiving (at step 402) a transfer request from the target aerial cell 306 to transfer each of a first plurality of link related parameters between the source aerial cell 304 and a plurality of user equipment (UEs) and a second plurality of link related parameters between the source aerial cell 304 and a core network. As an example, the target aerial cell 306 transmits the transfer request to the source aerial cell to transfer link related parameters between the source aerial cell 304 and UE connected to the source aerial cell 304, and another link related parameters between the source aerial cell 304 and the terrestrial cells (such as terrestrial cell 308) within a range of the core network 310. The replacement method is triggered at a time when it is detected that cell 304A within the source aerial cell 304 is energy depleted.

According to an embodiment of the present disclosure, each of the first plurality of link related parameters and the second plurality of link related parameters corresponds to information elements (IE) parameters. The IE parameters of the first plurality of link related parameters may include, but is not necessarily limited to including, physical channel configuration parameters, transport channel configuration parameters, logical channel configuration parameters, state-related parameters, and sub-state related parameters that are required for data sessions between each UE 302 among the plurality of UE (although not shown in FIG. 3) and the source aerial cell 304. The physical channel configuration parameters may include, for each of the plurality of UE required for maintaining sessions between the source aerial cell 304 and a corresponding UE 302 of the plurality of UE, terrestrial network parameters, at least one of Synchronization Signal Block (SSB) configuration, BWP configuration, reference signals, Channel State Information Reference Signal (CSI-RS), Physical Downlink Shared Channel (PDSCH) configuration, Physical Downlink Control Channel (PDCCH) configuration, Transmission Configuration Indication (TCI) state list, carrier aggregation configurations, power control parameters, link budget parameters, and CSI reports sent by each of the plurality of UE to the source aerial cell 304.

According to an embodiment of the present disclosure, the IE parameters may also include Radio Resource Control (RRC) configuration parameters. Further, the IE parameters may also include the reference signal received power (RSRP) threshold as one of the RRC configuration parameters.

According to an embodiment of the present disclosure, the IE parameters of the second plurality of link related parameters may also include, but is not necessarily limited to including, physical channel configuration parameters, transport channel configuration parameters, logical channel configuration parameters, state-related parameters, and sub-state related parameters that are required for maintaining sessions between the source aerial cell 304 and the core network 310 including terrestrial cells.

The aforementioned link related parameters are also shown below in Table 1. The link related parameters as shown in Table 1 are shown for ease of explanation and are not necessarily limited to the information included in Table 1. Those skilled in the art will appreciate that the aforementioned example is exemplary.

TABLE 1
Aerial cell link information elements (IE) parameters.

| Parameter | Details |
|---|---|
| UE to Aerial Cell | IEs at the source aerial cell, like physical |
| (A2G Link) for | channel, transport channel, logical channel |
| each UE | configuration, states, and sub-state related |
| | parameters required for data sessions for |
| | each UE. IEs like states and data values at |
| | Physical Layer, Radio Resource Control |
| | (RRC), Medium Access Control (MAC), |
| | Radio Link Control (RLC), Packet Data |
| | Convergence Protocol (PDCP), and |
| | Service Discovery Application Protocol |
| | (SDAP) layers that will aid to resume |
| | 3GPP related procedures at respective |
| | protocol layers between each UE and |
| | target aerial cell. |
| Aerial cell to | IEs like physical channel, transport |
| Terrestrial Cell | channel, logical channel configuration, |
| (A2T link) | states, and sub-state related variables |
| | required for sessions between aerial cell |
| | and terrestrial network (P2P link or IAB |
| | link). |
| Aerial cell | IE containing the precise location of the |
| positioning | source aerial cell, where the target aerial |
| information | cell must relocate to before starting the |
| | operation after link replication. |

The flow of the method 400 now proceeds to (step 404). At step 404, subsequent to the reception of the transfer request from the target aerial cell 306, the method 400 further comprises transmitting, to the target aerial cell, each of the first plurality of link related parameters and the second plurality of link related parameters in response to the received transfer request. As an example, the target aerial cell 306 receives each of the first plurality of link related parameters and the second plurality of link related parameters in response to the transmitted transfer request. Thereafter, the target aerial cell 306 stores each of the first plurality of link related parameters and the second plurality of link related parameters in a link database and further performs a link replication process to replicate each of the first plurality of link related parameters and the second plurality of link related parameters for cloning the source aerial cell 304. The flow of the method 400 now proceeds to (step 406).

At step 406, subsequent to the transmission of the first plurality of link related parameters and the second plurality of link related parameters to the target aerial cell 306, the method 400 comprises notifying, via a notification message after completion of the link replication process at the target aerial cell 306, a change in Physical Cell Identifier (PCID) of the source aerial cell 304 to the plurality of UE. As an example, the source aerial cell 304 notifies the change in PCID of the source aerial cell 304 to the target aerial cell 306 via the notification message. The notification message includes, but is not necessarily limited to including, an activation time, a plurality of parameters including new Cell Radio Network Temporary Identifier (C-RNTI), and security algorithm identifiers of the target aerial cell 306. The flow of the method 400 now proceeds to (step 408).

At step 408, subsequent to the transmission of the notification message to the plurality of UE, the method 400 comprises transmitting, after an acknowledgment of the notification message by the plurality of UE, a cell switching request to the target aerial cell 306 along with positioning information of the source aerial cell 304 for a switchover of a communication operation with the plurality of UE and terrestrial cells of the core network 310 served by the source aerial cell 304. As an example, the target aerial cell 306 receives the cell switching request along with positioning information from the source aerial cell 304 to switchover the communication operation with the plurality of UE and terrestrial cells served by the source aerial cell 304. Thereafter, one or more processor of the target aerial cell 306 controls the target aerial cell 306 to move to a hovering position indicated in the received positioning information. Here, the hovering position is a position at which the source aerial cell 304 is placed and from where the source aerial cell 304 is serving the UE and the terrestrial cells. Furthermore, once the target aerial cell 306 is moved to the hovering position, then the target aerial cell 306 establishes a communication with the plurality of UE and the terrestrial cells that were served by the source aerial cell 304 based on the replicated link parameters using the replication process and the switch over of the communication operation.

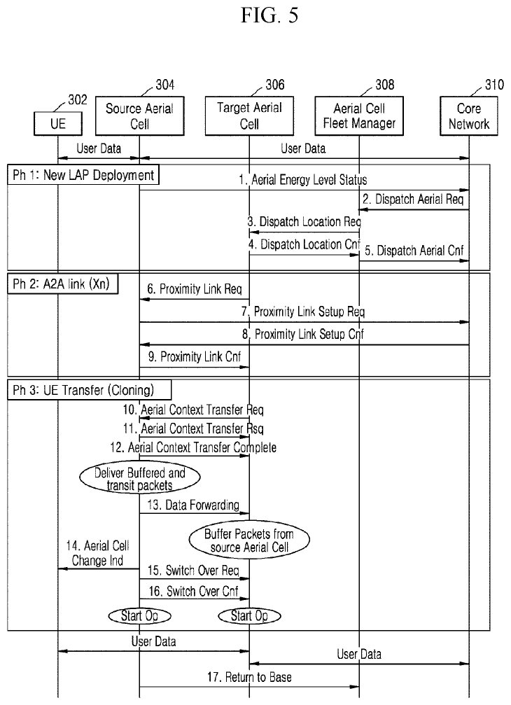

Now a detailed representation of the method 400 will be described with reference to FIG. 5 illustrating a line diagram representing a call flow for aerial cell replacement using ACC Protocol, in accordance with an embodiment of the present disclosure.

The aerial cell replacement using ACC Protocol is triggered for network management when the target aerial cell 306 comes into close proximity to the energy-depleted source aerial cell 304. In FIG. 5, the ACC protocol is represented in a form of a call flow. There are three phases as present in the representation. The dotted dashed line captures the key signaling differences that bring in the optimization in Phases 2 and 3 as shown in FIG. 5, in comparison to the comparative schemes of FIG. 1 and FIG. 2.

FIG. 5 depicts the UE 302, the source aerial cell 304, the target aerial cell 306, the aerial cell fleet manager 312, and the core network 310, according to an embodiment of the present disclosure. It is noted that elements presented in FIG. 5 are at least similar to corresponding elements that are shown and described with reference to FIG. 3.

Step 1 to step 5 of FIG. 5, illustrate the first phase of the deployment of the target aerial cell 306 in place of the source aerial cell 304 which is like the classical handover-based scheme as shown in FIG. 1 of the drawings.

Further, step 6 to step 9 of FIG. 5, illustrate the second phase of the deployment indicating aerial link establishment between the target aerial cell 306 and the source aerial cell 304. As soon as the target aerial cell 306 navigates to the source aerial cell 304, the target aerial cell 306 tries to establish a peer-to-peer link (for example, a device to device (D2D) side link) with the source aerial cell 304 in step 6 of FIG. 5. The source aerial cell 304 refers this request back to the core network 310 with the credentials of the target aerial cell 306 that it receives in the peer-to-peer link request in step 7 of FIG. 5. Further, in step 8 of the second phase of FIG. 5, the core network 310 confirms the request after authenticating the target aerial cell 306 credential, and thereafter the peer-to-peer link gets established in step 9 of FIG. 5.

Furthermore, step 10 to step 16 of FIG. 5, illustrate the third phase indicating UE transfer (cloning) to the target aerial cell 306. In step 10 of FIG. 5, the target aerial cell 306 proceeds with a request to transfer all the link related parameters between the source aerial cell 304 and the UE 302, and between the source aerial cell 304 and the backhaul link of the terrestrial network as described above at method step 402 of FIG. 4. Table 1 as shown above captures the Information Elements (IEs) comprising of the parameters for the source aerial cell 302 to each of the UE 302, i.e., air-to-ground (A2G) link and the source aerial cell 302 to the terrestrial cell 308 i.e., air-to-terrestrial (A2T) link. Thereafter, in step 11 of FIG. 5, the source aerial cell 302 transfers all these IEs, which is then applied by the target aerial cell 306 to replicate the A2G and A2T links. The target aerial cell 306 completes the link replication process, by copying the parameters in its link database, and then in step 12 of FIG. 5, it informs the source aerial cell 304 about the completion of the replication process.

Further, the source aerial cell 304 transfers the buffered data packets from the source aerial cell 304 to the target aerial cell 306 for all the UE 302 in step 13 of FIG. 5. In step 14 of FIG. 5, the source aerial cell 304 informs all the served UE about the change in the PCID as described above in the method flow 400 with an activation time, and additional parameters like C-RNTI, and the target aerial cell's security algorithm identifiers.

Furthermore, the source aerial cell 304 requests for the switch over to the target aerial cell 306 in step 15 of FIG. 5, and thereafter the source aerial cell 304 stops the operation of communication with the UE, and with the terrestrial cells on the backhaul link, and drifts away from the previous position at which it was hovering. The target aerial cell 306 then moves to the same precise location of the source aerial cell 304 as indicated in the received IE parameters (Aerial cell positioning information) given in Table 1 as shown above. Then, in step 16 of FIG. 5, the target aerial cell 306 issues a switch over confirmation to the source aerial cell 304 and starts communicating with UE after the activation time. In particular, the source aerial cell 304 receives an acknowledgment message from the target aerial cell 306 indicating confirmation of reception of the cell switching request in response to the transmitted cell switching request, and then one or more processors of the source aerial cell 304 controls the source aerial cell 304 to drift away from the hovering position in response to the received acknowledgment message. Then the target aerial cell 306 establishes the communication with the plurality of UE and the terrestrial cells of the core network 310 after disconnection of communication operation of the source aerial cell 304 with the plurality of UE and the terrestrial cells.

Here, the activation time is extremely small (e.g., a few milliseconds (ms)). Thus, the UE within the system are seamlessly and implicitly handed over to the target aerial cell 306. As the link parameters as well as the location of the source aerial cell are replicated, and therefore there will be no perceived interruption for data session between the source aerial cell 304 and the UE during the replacement.

Since, the ACC protocol of the present disclosure provides a method for replicating the source aerial cell, with a new target aerial cell at the same position (location coordinates) of the source aerial cell, this ensures that the uplink and downlink synchronization as well as the air to ground (A2G) channel characteristics between the source aerial cell and served UE, and between the source aerial cell and the terrestrial cell is retained. It also ensures that the radio configuration between the target aerial cell and the UE after the replacement stays the same as that of the configuration between the source aerial cell and the UE before the replacement. The change in Physical Cell Identifier (PCID) of the target aerial cell which is notified to the UE helps in avoiding any additional messaging.

According to an embodiment of the present disclosure, when an old aerial cell (e.g., a source aerial cell 304) is replaced by a new aerial cell (e.g., a target aerial cell 306), the whole access stratum (or the state of the base band unit (BBU)) is transferred from the old aerial cell to the new aerial cell. The access stratum state and data may be compressed before transfer at the old aerial cell and decompressed after transfer at the new aerial cell. For this purpose, optimization is done with respect to the total time of replacement which includes the sum of compression, data transfer, and decompression times. Further, the MAC scheduler should also transfer parameters related to multiuser scheduling for the whole cell.

Furthermore, in view of the above-described method 400 of FIG. 4 and call flow of FIG. 5, the following methods can be realized for exact replacement of the source aerial cell 304 so that there is no perceived interruption for data session between the source aerial cell 304 and the UE 302 during the replacement.

One such method is enforcing an RRC_INACTIVE condition for each of the plurality of UE for a specific time period before the movement of the target aerial cell 306 to the hovering position of the source aerial cell 304. In this method, the one or more processors of the source aerial cell 304 enforce, based on the RRC configuration parameters, the RRC_INACTIVE condition for each of the plurality of UE for the specific time period before the movement of the target aerial cell 306 to the hovering position at which the source aerial cell 304 was placed, and subsequent to this, the one or more processors of the source aerial cell 304 controls each of the plurality of UE to return in an active state based on enforcement of an RRC_ACTIVE condition for each of the plurality of UE after the movement of the target aerial cell 306 to the hovering position of the source aerial cell 304.

According to an embodiment of the present disclosure, a method that can be realized for exact replacement of the source aerial cell 302 is enforcing, in an RRC_ACTIVE state, a Connected Mode Discontinuous Reception (C-DRX) condition for each of the plurality of UE 302 before the movement of the target aerial cell 306 to the hovering position of the source aerial cell 304 such that each of the plurality of UE 302 enters into a long DRX cycle. In this method, the source aerial cell 304 enforces the C-DRX condition for each of the plurality of UE 302 in the RRC_ACTIVE state.

According to an embodiment of the present disclosure, a method that can be realized for exact replacement of the source aerial cell 304 is adjusting the RRC configuration parameters to increase an occurrence of a number of beam failure instances that can be tolerated by each of the plurality of UE 302 before detection of a beam failure and triggering of a beam recovery operation. In particular, the source aerial cell 304 modifies the RRC configuration parameters such as a value of the RSRP threshold before the detection of the beam failure and triggering of the beam recovery operation by the UE 302. As an example, in this method, 3GPP RRC IEs such as RadioLinkMonitoringConfig and BeamFailureRecoveryConfig are used. Considering, for example, the source aerial cell 304 has 8 SSBs (SSB0, SSB1, SSB7). Out of these 4 SSBs (SSB0 to SSB3) are being used to serve the UE in the current cell. Configuration can be made to include these SSBs in the RadioLinkMonitoring Config IE. A UE 302 under the current aerial cell will continuously monitor SSB0 to SSB3 for current downlink radio conditions. Further, SSB4 to SSB7, which are not currently used, could be made part of BeamFailureRecoveryConfig for the current aerial cell. Whenever a beam failure is detected, the UE 302 will try to re-establish a connection using SSB4 through SSB7. Hence, for aerial cell replacement, the old aerial cell (e.g., the source aerial cell 304) can reduce the power of its SSBs (SSB0 to SSB3). During this period, the new aerial cell (e.g., the target aerial cell 306) can increase the power of its SSBs (SSB4 to SSB7) and the Physical cell ID of both the old and the new aerial cell should remain the same. Therefore, there is no constraint on the rate of decrease and increase of SSB power because this replacement is handled using beam failure recovery. Also, a UE 302, upon detecting that the RSRP of an SSB (of the old aerial cell) when fallen below a predetermined threshold will detect a beam failure event and will trigger a beam failure recovery (BFR) procedure. Therefore, the BFR procedure will trigger a Beam failure Recovery random-access channel (BFR-RACH) using the occasions as provided by SSBs of the new aerial cell (SSB4 through SSB7) and thus each of the UE 302 can be seamlessly transferred to the new aerial cell (e.g., the target aerial cell 306).

The ACC replacement method and system of the present disclosure may result in the reduction of the delays to, for example, substantially near zero, in handover and data session interruption in comparison to the delay during handover in the first comparative scheme.

The ACC replacement method and system of the present disclosure may also reduce the degradation of the throughput which tends to occur in the comparative scheme of aerial cell link management.

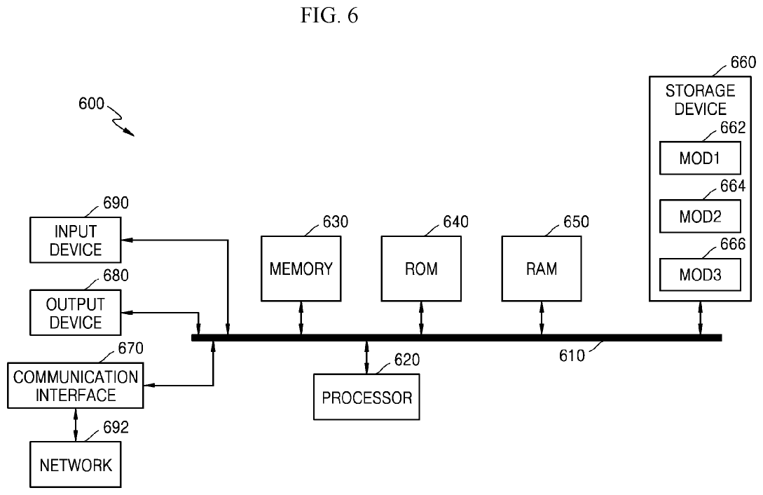

Referring now to FIG. 6, FIG. 6 illustrates an exemplary implementation in accordance with the embodiment of the present invention, and a hardware configuration of the system in the form of a computer system 600, in accordance with an embodiment of the present disclosure.

The computer system 600 includes a processing unit (CPU or other processor) 620 and a system bus 610 that couples various system components including the system memory 630 such as read-only memory (ROM) 640 and random access memory (RAM) 650 to the processor 620. The system 600 also includes a cache of high-speed memory connected directly with, in close proximity to, or integrated as part of the processor 620. The system 600 copies data from the memory 630 and/or the storage device 660 to the cache for quick access by the processor 620. These and other modules can control or be configured to be controlled by the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general-purpose processor and a hardware module or software module, such as a first module (MOD1) 662, a second module (MOD2) 664, and a third module (MOD3) 666 stored in storage device 660. The processor 620 may essentially be a completely self-contained computing system, containing multiple cores or processors, a bus, memory controller, cache, etc. (such as a system-on-chip). A multi-core processor may be symmetric or asymmetric.

The system bus 610 may be any of several types of bus structures including a memory bus or memory controller, a peripheral bus, and a local bus using any of a variety of bus architectures. The computing system 600 further includes storage devices 660 such as a hard disk drive, a magnetic disk drive, an optical disk drive, a tape drive, a solid-state drive, or the like. The storage device 660 can include software modules 662, 664, 666 for controlling the processor 620. Other hardware or software modules are contemplated. The storage device 660 may be connected to the system bus 610 by a drive interface. The drives and the associated computer-readable storage media provide nonvolatile storage of computer-readable instructions, data structures, program modules, and other data for the computing system 600. In one aspect, a hardware module that performs a particular function includes the software component stored in a tangible computer-readable storage medium in connection with the necessary hardware components, such as the processor 620, bus 610, input device 690, and output device 680, and so forth, to carry out the function. The basic components and appropriate variations are contemplated depending on the type of systems, such as whether the computing system 600 is a small, aerial-based movable computing device, or a portable device capable of being hover in the LAP platform.

The computer system 600 may also include a network 692 connected to the communication interface 670. The network 692 may include wired networks, wireless networks, Ethernet AVB networks, or combinations thereof. The wireless network may be a cellular telephone network, an IEEE 802.11, 802.16, 802.20, 802.1Q or WiMax network. Further, the network 692 may be a public network, such as the Internet, a private network, such as an intranet, or combinations thereof, and may utilize a variety of networking protocols now available or later developed including, but not necessarily limited to including, TCP/IP based networking protocols. The system is not necessarily limited to operation with any particular standards and protocols. For example, standards for Internet and other packet-switched network transmissions (e.g., TCP/IP, UDP/IP, HTML, and HTTP) may be used.

As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not necessarily limited to the manner described herein.

Moreover, the actions of any flow diagram need not be implemented in the order shown; nor do all of the acts necessarily need to be performed. Also, those acts that are not dependent on other acts may be performed in parallel with the other acts.

1. A method of replacing a source aerial cell with a target aerial cell, comprising:
receiving, by at least one processor of the source aerial cell, a transfer request from the target aerial cell to transfer each of a first plurality of link related parameters between the source aerial cell and a user equipment (UE) and to transfer each of a second plurality of link related parameters between the source aerial cell and a core network;
transmitting, by the at least one processor to the target aerial cell, each of the first plurality of link related parameters and each of the second plurality of link related parameters in response to the received transfer request, wherein the target aerial cell stores each of the first plurality of link related parameters and each of the second plurality of link related parameters in a link database and performs a link replication process for replicating the first plurality of link related parameters and the second plurality of link related parameters;
notifying, by the at least one processor, to the UE via a notification message after completion of the link replication process at the target aerial cell, a change in Physical Cell Identifier (PCID) of the source aerial cell; and
transmitting, by the at least one processor to the target aerial cell, after an acknowledgment of the notification message by the UE, a cell switching request along with positioning information of the source aerial cell for a switchover of a communication operation with the UE and terrestrial cells of the core network served by the source aerial cell,
wherein the target aerial cell moves to a hovering position indicated by the transmitted positioning information, and
wherein the target aerial cell establishes communication with the UE and the terrestrial cells served by the source aerial cell based on the link replication process and the switch over of the communication operation.

2. The method as claimed in claim 1,
wherein the UE is connected to the source aerial cell via a wireless interface, and
wherein each of the first plurality of link related parameters and each of the second plurality of link related parameters corresponds to information elements (IE) parameters.

3. The method as claimed in claim 2,
wherein the IE parameters include physical channel configuration parameters, transport channel configuration parameters, logical channel configuration parameters, state related parameters, and sub-state related parameters that are used for data sessions between the UE and the source aerial cell, and
wherein the physical channel configuration parameters include, for the UE, used for maintaining sessions between the source aerial cell and the UE, terrestrial network parameters, at least one of Synchronization Signal Block (SSB) configuration, BWP configuration, reference signals, Channel State Information Reference Signal (CSI-RS), Physical Downlink Shared Channel (PDSCH) configuration, physical downlink control channel (PDCCH) configuration, transmission configuration indication (TCI) state list, Carrier aggregation configurations, power control parameters, link budget parameters, and CSI reports sent by the UE to the source aerial cell.

4. The method as claimed in claim 2, wherein the IE parameters include physical channel configuration parameters, transport channel configuration parameters, logical channel configuration parameters, state related parameters, and sub-state related parameters that are used for maintaining sessions between the source aerial cell and the core network.

5. The method as claimed in claim 2,
wherein the IE parameters further include Radio Resource Control (RRC) configuration parameters, and
wherein the method further comprises:
enforcing, by the at least one processor based on the RRC configuration parameters, an RRC_INACTIVE condition for the UE for a specific time period before the movement of the target aerial cell to the hovering position of the source aerial cell; and
controlling, by the at least one processor, the UE to return to an active state based on enforcement of an RRC_ACTIVE condition for the UE after the movement of the target aerial cell to the hovering position of the source aerial cell.

6. The method as claimed in claim 2, further comprising enforcing, by the at least one processor in an RRC_ACTIVE state, a Connected Mode Discontinuous Reception (CDRX) condition for the UE before the movement of the target aerial cell to the hovering position of the source aerial cell such that the UE enters into a long DRX cycle.

7. The method as claimed in claim 2,
wherein the IE parameters further include Radio Resource Control (RRC) configuration parameters, and
wherein the method further comprises adjusting, by the at least one processor, the RRC configuration parameters to increase an occurrence of a number of beam failure instances that can be tolerated by the UE before detection of a beam failure and triggering of a beam recovery operation.

8. (canceled)

9. The method as claimed in claim 1, wherein the notification message includes an activation time, a plurality of parameters including new Cell Radio Network Temporary Identifier (C-RNTI), and security algorithm identifiers of the target aerial cell.

10. The method as claimed in claim 1, further comprising:
receiving, by the at least one processor from the target aerial cell, an acknowledgment message indicating confirmation of reception of the cell switching request in response to the transmitted cell switching request, and
controlling, by the at least one processor, the source aerial cell to drift away from the hovering position in response to the received acknowledgment message,
wherein the target aerial cell further establishes the communication with the UE and the terrestrial cells after disconnection of communication operation of the source aerial cell with the UE and the terrestrial cells.

11. A method of placing a target aerial cell in place of a source aerial cell, comprising:
transmitting, by at least one processor of the target aerial cell, a transfer request to the source aerial cell to transfer each of a first plurality of link related parameters between the source aerial cell and user equipment UE and a second plurality of link related parameters between the source aerial cell and a core network;
receiving, by the at least one processor, each of the first plurality of link related parameters and the second plurality of link related parameters in response to the transmitted transfer request;
performing, by the at least one processor, a link replication process for replicating each of the received first plurality of link related parameters and each of the received second plurality of link related parameters, wherein the source aerial cell notifies the UE about a change in Physical Cell Identifier (PCID) of the source aerial cell via a notification message, after completion of the link replication process;
receiving, by the at least one processor from the source aerial cell, a cell switching request along with positioning information of the source aerial cell for a switchover of a communication operation with the UE and terrestrial cells of the core network served by the source aerial cell, wherein the source aerial cell transmits the cell switching request to the target aerial cell after an acknowledgment of the notification message by the UE;
controlling, by the at least one processor, the target aerial cell to move to a hovering position indicated in the received positioning information; and
establishing, by the at least one processor after the movement of the target aerial cell to the hovering position, a communication with the UE and the terrestrial cells served by the source aerial cell based on the link replication process and the switch over of the communication operation.

12. The method as claimed in claim 11, further comprising storing, by the at least one processor in a link database, each of the received first plurality of link related parameters and each of the received second set of link related parameters, wherein each of the first plurality of link related parameters and each of the second plurality of link related parameters corresponds to information elements (IE) parameters.

13. The method as claimed in claim 12,
wherein the IE parameters include physical channel configuration parameters, transport channel configuration parameters, logical channel configuration parameters, state related parameters, and sub-state related parameters that are used for data sessions between the UE and the source aerial cell, and
wherein the physical channel configuration parameters include, terrestrial network parameters, at least one of Synchronization Signal Block (SSB) configuration, BWP configuration, reference signals, Channel State Information Reference Signal (CSI-RS), Physical Downlink Shared Channel (PDSCH) configuration, physical downlink control channel (PDCCH) configuration, transmission configuration indication (TCI) state list, Carrier aggregation configurations, power control parameters, link budget parameters, and CSI reports sent by the UE to the source aerial cell.

14. The method as claimed in claim 12, wherein the IE parameters include physical channel configuration parameters, transport channel configuration parameters, logical channel configuration parameters, state related parameters, and sub-state related parameters that are used for maintaining sessions between the source aerial cell and the core network.

15. The method as claimed in claim 12, wherein the IE parameters further include Radio Resource Control (RRC) configuration parameters, and
wherein the source aerial cell:
enforces, based on the RRC configuration parameters, an RRC_INACTIVE condition for the UE for a specific time period before the movement of the target aerial cell to the hovering position of the source aerial cell, and
controls the UE to return in an active state based on enforcement of an RRC_ACTIVE condition for the UE after the movement of the target aerial cell to the hovering position of the source aerial cell.

16. The method as claimed in claim 12, wherein the source aerial cell enforces, in an RRC_ACTIVE state, a Connected Mode Discontinuous Reception (C-DRX) condition for the UE before the movement of the target aerial cell to the hovering position of the source aerial cell such that the UE enters into a long DRX cycle.

17. (canceled)

18. The method as claimed in claim 11, further comprising:
transmitting, by the at least one processor to the source aerial cell, an acknowledgment message indicating confirmation of reception of the cell switching request in response to the received cell switching request, wherein the source aerial cell drifts away from the hovering position in response to the transmitted acknowledgment message; and
establishing, by the at least one processor, the communication with the UE and the terrestrial cells after disconnection of communication operation of the source aerial cell with the UE and the terrestrial cells.

19. A source aerial cell replaceable by a target aerial cell, the source aerial cell comprising at least one processor configured to:
receive a transfer request from the target aerial cell to transfer each of a first plurality of link related parameters between the source aerial cell and a user equipment UE and each of a second plurality of link related parameters between the source aerial cell and a core network;
transmit, to the target aerial cell, each of the first plurality of link related parameters and each of the second plurality of link related parameters in response to the received transfer request, wherein the target aerial cell stores each of the first plurality of link related parameters and each of the second plurality of link related parameters in a link database and performs a link replication process for replication of the each of the first plurality of link related parameters and each of the second plurality of link related parameters;
notify, to the UE via a notification message after completion of the link replication process at the target aerial cell, a change in Physical Cell Identifier (PCID) of the source aerial cell; and
transmit, to the target aerial cell after an acknowledgment of the notification message by the UE, a cell switching request along with positioning information of the source aerial cell for a switchover of a communication operation with the UE and terrestrial cells of the core network served by the source aerial cell,
wherein the target aerial cell moves to a hovering position indicated by the transmitted positioning information, and
wherein the target aerial cell establishes a communication with the UE and the terrestrial cells served by the source aerial cell based on the link replication process and the switch over of the communication operation.

20. The source aerial cell according to claim 19,
wherein the UE is connected to the source aerial cell via a wireless interface, and
wherein each of the first plurality of link related parameters and each of the second plurality of link related parameters corresponds to information elements (IE) parameters.

21-23. (canceled)

24. The source aerial cell according to claim 19, wherein the notification message includes an activation time, a plurality of parameters including new Cell Radio Network Temporary Identifier (C-RNTI), and security algorithm identifiers of the target aerial cell.

25. The source aerial cell according to claim 19, wherein the at least one processor is further configured to:
receive, from the target aerial cell, an acknowledgment message indicating confirmation of reception of the cell switching request in response to the transmitted cell switching request, and
control the source aerial cell to drift away from the hovering position in response to the received acknowledgment message, wherein the target aerial cell further establishes the communication with the UE and the terrestrial cells after disconnection of communication operation of the source aerial cell with the UE and the terrestrial cells.

26-29. (canceled)
